(19) United States
(12) Patent Application Publication
(10) Pub. No.: US 2020/0404935 A1
(43) Pub. Date: Dec. 31, 2020

(54) NEEDLE REGISTER

(71) Applicant: SCHRÖDER MASCHINENBAU GMBH & CO. KG, Werther (DE)

(72) Inventor: Peter J. Danwerth, Steinhagen (DE)

(73) Assignee: SCHRÖDER MASCHINENBAU GMBH & CO. KG, Werther (DE)

(21) Appl. No.: 16/643,951

(22) PCT Filed: Aug. 21, 2018
(86) PCT No.: PCT/EP2018/072540

§ 371 Date: Mar. 3, 2020

(30) Foreign Application Priority Data
Sep. 4, 2017 (EP) 17189274.8

(51) Int. Cl. A23B 4/28; A22C 17/00

(52) U.S. Cl. CPC A23B 4/285; A22C 17/0053

(57) ABSTRACT

A needle register for injection apparatus for injecting liquid into food products, comprising: a needle carrier (10) forming a distribution chamber (16) for the liquid; a plurality of parallel hollow needles (12) which are held on the needle carrier (10) such that their open top ends are disposed inside the distribution chamber (16); and at least one perforated plate (30) that is removably received in the distribution chamber (16), a plurality of the needles (12) being held in the perforations of the perforated plate, characterized in that the needles (12) are firmly fitted into the perforations of the perforated plate (30).

The invention relates to a needle register for injection apparatus for injecting liquid into food products, the needle register comprising: a needle carrier forming a distribution chamber for the liquid; a plurality of parallel hollow needles that are held on the needle carrier such that their open top ends are disposed inside the distribution chamber; and at least one perforated plate which is removably received in the distribution chamber, a plurality of the needles being held in the perforations of the perforated plate.

Examples for injection apparatus in which such needle registers are employed comprise pickling apparatus for injecting brine into meat products.

EP 2 545 782 A2 discloses a needle register of this type in which the top ends of the needles each have a collar that is sandwiched between two superposed perforated plates. This facilitates a replacement of the needles.

Because the liquids that are injected into food products come into contact with the internal surfaces of the needles and the distribution chamber, a regular and careful cleaning of the needle register is indispensable.

It is an object of the invention to provide a needle register that is easy to clean.

In order to achieve this object, according to the invention, the needles are firmly fitted into the perforations of the perforated plate.

Since the top ends of the needles need not be clamped between two perforated plates anymore, the insertion of the perforated plates and the needles into the needle register as well as the removal of the needle-carrying perforated plates is facilitated substantially. Moreover, the invention reduces joints and dead spaces in which dirt could accumulate. Useful details of the invention are indicated in the dependent claims.

In one embodiment the needles are welded into the perforations of the perforated plate, e.g. by laser welding or friction welding.

When the needles are firmly welded into the perforated plate, they can no longer be detached from the perforated plate individually. This, however, does not impede the handling of the needles during cleaning operation but on the contrary leads rather to an easier handling.

In another embodiment the needles can be press-fitted or shrink-fitted in the perforations of the perforated plate.

In a useful embodiment the distribution chamber is rotatably supported in a frame so that, once the perforated plate and the needles have been removed, it can be rotated into a position in which the bottom side of the distribution chamber from which the needles would project faces upwards or is upwardly inclined, so that this bottom side is more easily accessible during cleaning operations.

This feature may also be advantageous by itself, independently of the features of claim 1. The invention therefore discloses also a needle register for injection apparatus for injecting liquid into food products, comprising: a needle carrier forming a distribution chamber for the liquid; a plurality of parallel, hollow needles that are held on the needle carrier such that their open ends are disposed inside the distribution chamber; and at least one perforated plate that is removably accommodated in the distribution chamber, a plurality of the needles being held in the perforations of the perforated plate, characterized in that the distribution chamber is supported in a frame so as to be rotatable within the frame about an axis that extends in parallel with the bottom of the distribution chamber.

An embodiment example will now be described in conjunction with the drawings, wherein:

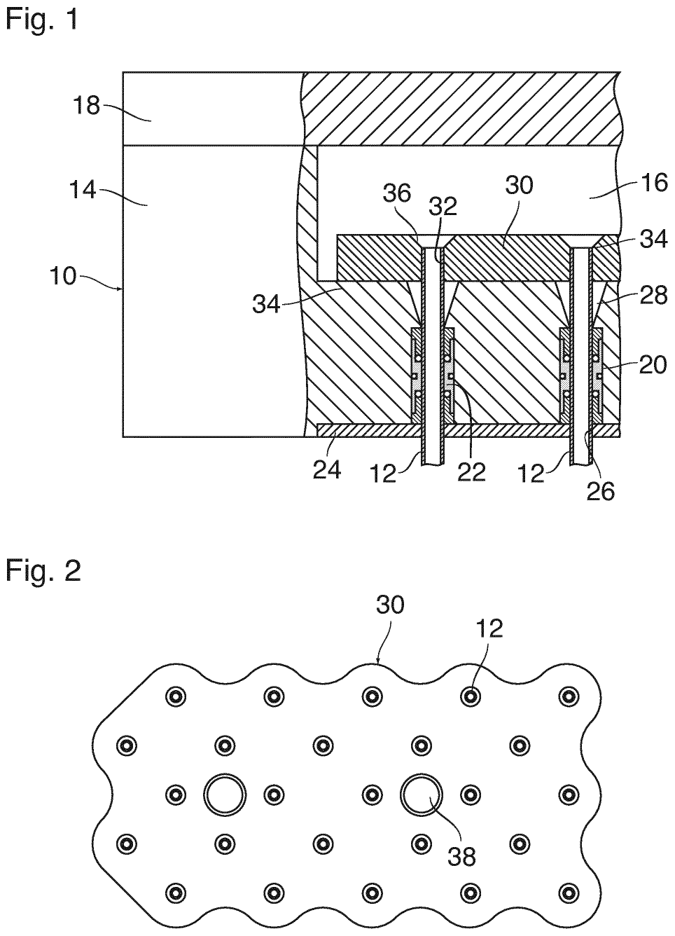

FIG. 1 is a partial sectional view of a needle register according to the invention;

FIG. 2 is a plan view of a single perforated plate with needles welded therein;

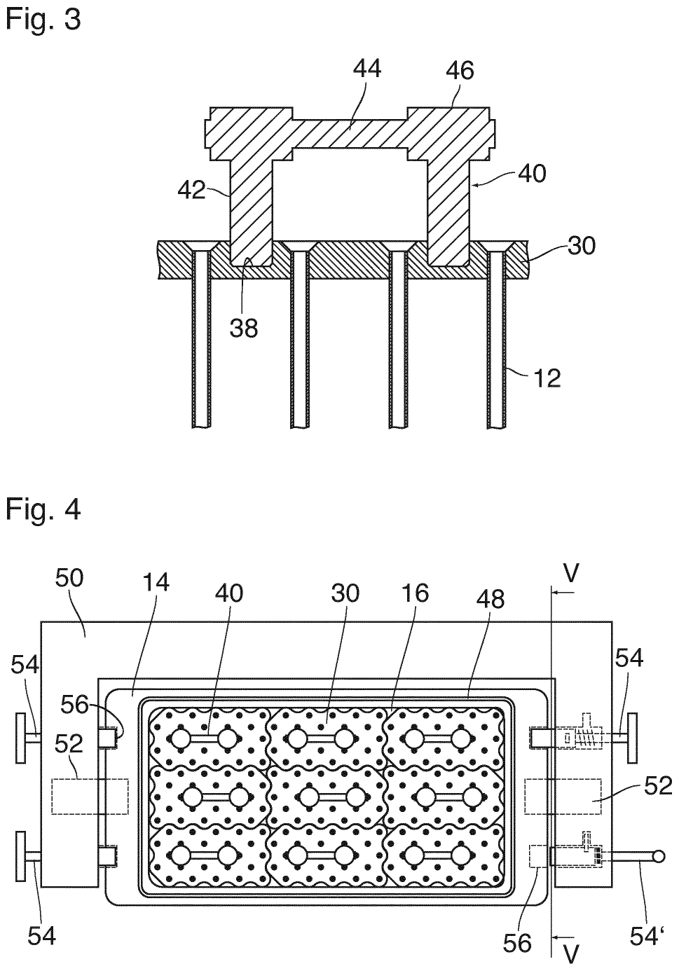

FIG. 3 is a partial sectional view of the perforated plate and some of the needles;

FIG. 4 shows, in a top view, the entire needle register according to FIG. 1 with a distribution chamber being open;

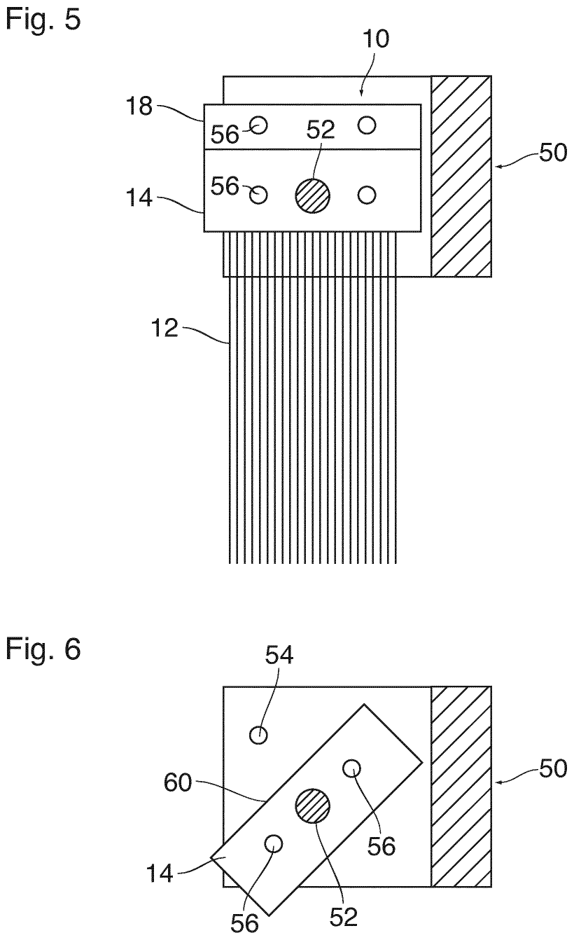

FIG. 5 a cross-section along the line V-V in FIG. 4;

FIG. 6 a sectional view of the needle register in a condition during cleaning operations;

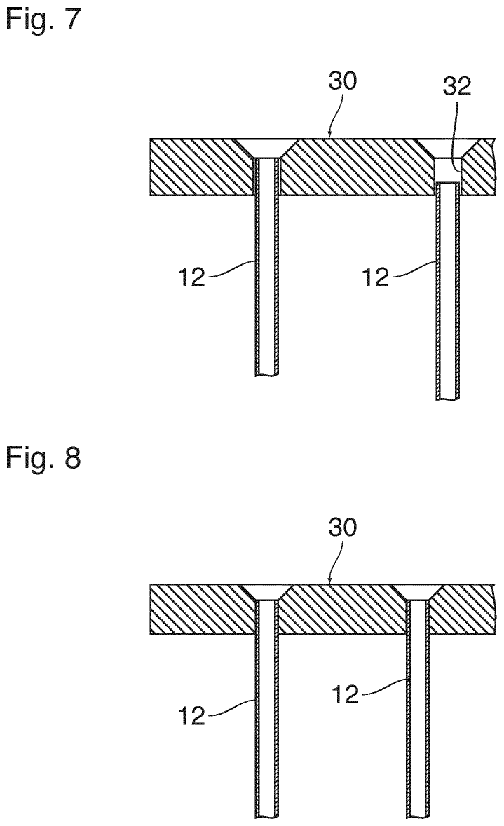

FIGS. 7 and 8 illustrate a method of shrink-fitting the needles in the perforated pate; and

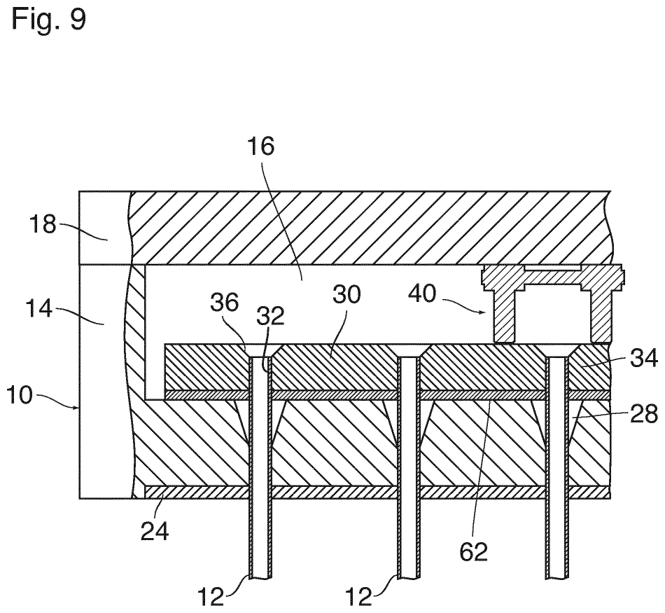

FIG. 9 is a partial sectional view of a needle register according to another embodiment.

FIG. 1 shows a part of a needle register that may for example serve for injecting pickling brine into pieces of meat in a pickling injector. The needle register has a needle carrier 10 carrying a plurality of hollow needles 12 which extend vertically downwards from the needle carrier 10.

In the pickling injector, the needle carrier 10 is arranged to be movable in vertical direction above a conveyor which has not been shown and on which the pieces of meat are supplied. When the needle carrier is lowered, the needles 12 penetrate into the meat, so that the brine can be injected.

The needle carrier 10 is formed by a block 14 of food-grade plastics which is recessed on the top side so as to form a relatively shallow, upwardly opening distribution chamber 16. By means of a cover plate 18 clamped onto the block 14, the distribution chamber 16 may be closed pressure-tightly. An end portion of the block 14, on the left side in FIG. 1, accommodates a valve assembly which has not been shown in detail and with which brine can be supplied under pressure into the distribution chamber 16.

The open top ends of the needles 12 are disposed within the distribution chamber 16, so that the brine can be distributed evenly over the needles and can be injected into the meat via the needles. The part of the block 14 that forms the bottom of the distribution chamber 16 has, for each of the needles 12, a seal chamber 20 which is open on the bottom side and accommodates an elastic seal packing set 22 for the needle. At the bottom end, the seal chambers 20 are closed by a closure plate 24 having bores through which the needles 12 can pass-through.

On the top side, each seal chamber 20 adjoints a passage 28 which flares-out conically towards the distribution chamber 16.

On the bottom of the distribution chamber 16 rests a perforated plate 30 that is made of metal and has a through-hole 32 for each needle.

Each needle 12 is fitted in one of the through-holes and is firmly welded to the perforated plate 30, e.g. by means of laser welding along an annular weld seam 34 at the top end of the needle and/or optionally also on the bottom side of the perforated plate.

In the example shown, each through-hole 32 has on the top side of the perforated plate a conically flaring part 36 which permits a smooth inflow of the brine from the distribution chamber 16 into the needle.

In FIG. 2, the perforated plate 30 has been shown in a top plan view, so that the top ends of the needles 12 are visible in the through-holes. The needles are arranged in a regular raster. The perforated plate 30 has an approximately rectangular shape but has a wavy edge the waves of which are adapted to the distance from needle to needle, so that even the needles disposed at the edge of the plate are surrounded by the sufficient amount of bulk material of the perforated plate. Two larger recesses 38 formed in the interior part of the perforated plate serve for mounting a handle 40, as has been shown in FIG. 3.

In the example shown, the handle 40 is a bow-shaped handle having two vertical pillars 42 the bottom ends of which are fixed in the recesses 38, e.g. by welding, and the top ends of which are interconnected by a bow 44. The pillars 42 have thickened and flattened top ends forming support surfaces 46 which can engage a bottom side of the cover plate 18 when the cover plate has been mounted, so that the needles and the perforated plate are backed by the cover plate via the handle 40 so as to absorb the reaction forces that occur when the needles penetrate into the food products.

FIG. 4 shows a top view of the needle register without cover plate. It can be seen that the distribution chamber 16 has, in plan view, an elongated rectangular shape with rounded corners, in which a plurality of perforated plates 30 have been fitted such that, together, they cover the entire bottom of the distribution chamber.

On the top side of the block 14, a seal 48 is provided along the edge of the distribution chamber 16 for sealing-off a joint between the block 14 and the cover plate 18 when the cover plate has been mounted.

The block 14 as well as the cover plate 18 are held in a C-shaped frame 50. The block 14 has stud axles 52 which are rotatably supported in the parallel legs of the frame 50. These legs further accommodate two pairs of locking bolts 54, 54′ for the block 14 and the cover plate 18. The locking bolts 54, 54′ are elastically biased into corresponding insertion holes 56 of the block 14 and the cover plate 18, respectively, but can be withdrawn manually and can be arrested in the withdrawn position by means of a 90° rotation, so that the block 14 and the cover plate 18 are locked to the frame 50. However, the locking mechanisms for the cover plate and the block 14 can be released independently of one another.

In FIG. 4, three of the four locking bolts 54 for the cover plate have been shown in the locking position. The fourth one of these locking bolts has not been shown, and instead, one of the four locking bolts 54′ for the block 14 has been shown in the bottom right corner in FIG. 4 in the non-locking position.

In FIG. 5, the frame 50 and one of the stud axles 52 have been shown in cross-section in a view onto the end face of the block 14 and the cover plate 18 and on the insertion holes 56 that are formed therein for receiving the locking bolts.

When the needle register is to be cleaned, the locking bolts 54 for the cover plate 18 are released and the cover plate is removed, so that the distribution chamber 16 in the interior of the needle register becomes accessible. By means of the handles 40, the perforated plates with the needles held therein can be drawn-out upwardly one after the other. Then, the perforated plates and the needles may be inserted into a suitably adapted cleaning apparatus for being cleaned.

FIG. 6 shows the needle register without the cover plate 18 and without the needles 12. In FIG. 6, the block 14 has been rotated about the axis defined by the stud axles 52 by an angle of approximately 135° in clock sense, so that the bottom side 60, i.e. the side of the block at which the needles 12 exit, faces slantingly upwards. This permits to thoroughly clean the block 14 also on the bottom side without having to remove the block from the frame 50. The distribution chamber 16 is conveniently cleaned when the block 14 assumes the non-rotated position shown in FIG. 5.

In a modified embodiment, the needles 12 may be fixed in the trough-holes 32 of the perforated plate 30 by shrink-fitting, as has been illustrated in FIG. 7. The perforated plate 30 is heated to an elevated temperature so that the dimensions of the plate and also the diameters of the through-holes 32 are increased due to thermal expansion. Then, the needles 12, which have not been heated, are smoothly inserted into the trough-hole and held in position while the plate is allowed to cool down. The corresponding shrinkage of the plate 30 results in a tight press-fit of the needles in the trough-holes 32 as shown in FIG. 8.

FIG. 9 shows a modified embodiment which differs from the embodiment shown in FIG. 1 in that an elastic mat-like seal gasket 62 is provided at the bottom side of the perforated plate 30 for tightly sealing the joint between the plate 30 and the bottom wall of the distribution chamber 16. As a consequence, no brine can enter into the conical passages 28, and the packing sets 22 and the seal chambers 20 shown in FIG. 1 can be dispensed with. Instead, the needles 12 simply pass through through-bores in the bottom wall of the block 14 and through corresponding holes in the gasket 62.

If the needle register has a plurality of perforated plates 30, as in FIG. 4, each perforated plate 30 may have its own gasket 62 which is congruent with the plate 30 and has through holes corresponding to the through-holes 32 of the plate. The gasket may be adhered to the bottom surface of the plate 30 so that it remains attached to the perforated plate when the plate and the set of needles are withdrawn.

When the plate 30 and the needles 12 have been re-inserted and the cover 18 is clamped onto the block 14, the handle 40 gently urges the perforated plate 30 against the gasket 62 so as to compress the same and to form a tight seal.

1. A needle register for injection apparatus for injecting liquid into food products, comprising:
a needle carrier forming a distribution chamber for the liquid;
a plurality of parallel hollow needles which are held on the needle carrier such that their open top ends are disposed inside the distribution chamber; and
at least one perforated plate that is removably received in the distribution chamber, a plurality of the needles being held in the perforations of the perforated plate, characterized in that the needles are firmly fitted into the perforations of the perforated plate.

2. The needle register according to claim 1, wherein the needles are welded into the perforations of the perforated plate.

3. The needle register according to claim 1, wherein the needles are shrink-fitted in the perforations of the perforated plate.

4. The needle register according to claim 1, wherein the distribution chamber accommodates a plurality of perforated plates with their respective needles.

5. The needle register according to claim 1, wherein each perforated plate has, on its top side, a handle for withdrawing the perforated plate and the needles from the distribution chamber.

6. The needle register according to claim 5, wherein the distribution chamber is closed by a cover plate and the needles and the perforated plates are backed against the cover plate via the handles.

7. The needle register according to claim 1, wherein a part of the needle carrier, which part forms the distribution chamber, is held in a frame and is rotatable relative to this frame by an angle of more than 90° about an axis that extends in parallel with a bottom face of the distribution chamber.

8. The needle register according to claim 1, wherein a mat-like sealing gasket is interposed between the perforated plate and a bottom wall of the distribution chamber.

9. The needle register according to claim 8, wherein the gasket is attached to the perforated plate.
